(19) United States
(12) Patent Application Publication
(10) Pub. No.: US 2015/0029467 A1
(43) Pub. Date: Jan. 29, 2015

(54) LIGHT SOURCE UNIT AND PROJECTOR

(71) Applicant: CASIO COMPUTER CO., LTD., Tokyo (JP)

(72) Inventors: Chihaya SUGIYAMA, Tokyo (JP); Masahiro OGAWA, Tokyo (JP)

(21) Appl. No.: 14/336,892

(22) Filed: Jul. 21, 2014

(30) Foreign Application Priority Data
Jul. 24, 2013 (JP) 2013-153274

(51) Int. Cl. H04N 9/31; F21V 14/08; F21V 29/02; F21V 9/10; F21V 8/00

(52) U.S. Cl. CPC H04N 9/3161; F21V 9/10; G02B 6/0001; F21V 29/027; F21V 14/08
USPC 353/31; 362/84

(57) ABSTRACT

A small light source unit is provided which emits lights of the primary colors which are highly bright and which have a high color reproducibility and excitation light, and the light source unit includes a light source module and a light source control module and the light source module has a first light source which emits light having a first wavelength which is used as excitation light which excites a luminescent material, and a second light source which emits light having a second wavelength which is different from the first wavelength but which falls within a range of wavelengths of light of a similar color to that of the light of the first light source, and the light source control module controls individually the illumination of the first light source and the second light source.

### CROSS-REFERENCE TO RELATED APPLICATION

This application is based upon and claims the benefit of priority under 35 USC 119 from Japanese Patent Application No. 2013-153274 filed on Jul. 24, 2013, the entire disclosures of which, including the description, claims, drawings and abstract, are incorporated herein by reference.

### BACKGROUND OF THE INVENTION

1. Field of the Invention

The present invention relates to a light source unit and a projector.

2. Description of the Related Art

In these days, data projectors are used on many occasions as an image projection system which projects images including an image of a screen and a video image of a personal computer, as well as images based on image data which is stored on a memory card on to a screen.

Conventionally, the mainstream of these data projectors has been those which utilize a high-intensity discharge lamp as a light source. In recent years, however, there have been made many developments and proposals on light source units which use, as a light source, light emitting diodes (LED), laser light emitting elements, organic electroluminescent elements, luminescent materials or the like.

For example, Japanese Unexamined Patent Publication No. 2004-341105 proposes a light source unit in which a red luminescent material layer, a green luminescent material layer and a blue luminescent material layer are provided in an end-to-end fashion on a front surface of a light emitting plate which is formed in a circular disc shape and has a light transmitting characteristics, and a dichroic filter which transmits ultraviolet radiation and reflects visible light is disposed on the rear surface of the light emitting plate so that ultraviolet light is shone onto the luminescent material layers from a rear surface side of the dichroic filter, whereby light source light having a wavelength in the red wavelength range, light source light having a wavelength in the green wavelength range, and light source light having a wavelength in the blue wavelength range are generated from the corresponding luminescent material layers.

In addition, the applicant of this patent application proposed in Japanese Unexamined Patent Publication No. 2011-013320, which was published based on the patent application that had been previously filed by the applicant, a light source unit which includes a blue laser light emitting element, a red light emitting diode and the following light emitting wheel. The light emitting wheel has a green luminescent material layer which emits light having a wavelength in the green wavelength range by using light emitted from the blue laser light emitting element as excitation light and a diffuse transmitting plate which diffuses and transmits light emitted from the blue laser light emitting element. And the green luminescent material and the diffuse transmitting plate are disposed circumferentially in an end-to-end fashion on the light emitting wheel.

This light source unit proposed by the applicant of this patent application generates light source light having a wavelength in the red wavelength range by means of the red light emitting diode and light source light having a wavelength in the green wavelength range by shining light emitted from the blue laser light emitting element to the green luminescent material layer on the light emitting wheel as excitation light.

In addition, the light source unit also emits light having a wavelength in the blue wavelength range by causing light emitted from the blue laser light emitting element to pass through the diffuse transmitting plate on the light emitting wheel in a diffuse manner.

In the light source unit according the previous patent application by the applicant of this patent application, the green luminescent material is used as the green light source, and the light in the blue wavelength range is used as the excitation light.

Because of this, in a projector in which the excitation light in the blue wavelength range which enhances the light emission efficiency of the green luminescent material is used as the light source light for a blue image, the tone of blue color of a projected image becomes unnatural, thereby making it difficult to increase the quality of the projected image.

### SUMMARY OF THE INVENTION

The invention has been made in view of the problem inherent in the light source unit according to the related art, and an object thereof is to provide a small light source unit which can emit lights of the primary colors which are highly bright and which have high reproducibility of colors and excitation light, and a projector equipped with this light source unit and which has high quality of the projected image.

According to a first aspect of the invention, there is provided a light source unit including a light source module and a light source control module, wherein the light source module has a first light source which emits a light having a first wavelength which is made use of as an excitation light which excites a luminescent material and a second light source which emits a light having a second wavelength which is different from the first wavelength but which falls within a range of wavelengths of light of a similar color to that of the light of the first light source, and wherein the light source control module controls individually the illumination of the first light source and the second light source.

According to a second aspect of the invention, there is provided a projector including the light source unit according to the first aspect of the invention, a display element which generates a projection light, a light source-side optical system which guides the light emitted from the light source unit to the display element, a projection-side optical system which guides a projection light generated in the display element, and a projector control unit which controls the display element and the light source unit.

### BRIEF DESCRIPTION OF THE SEVERAL VIEWS OF THE DRAWINGS

FIG. 1 is an external perspective view of a projector according to an embodiment of the invention.

FIG. 2 is a functional circuit block diagram of the projector according to the embodiment of the invention.

FIG. 3 is a schematic plan view showing an internal construction of the projector according to the embodiment of the invention.

FIG. 4 is a schematic front view of a light source module equipped in the projector according to the embodiment of the invention.

FIG. 5 is a schematic front view of a light emitting plate equipped in the projector according to the embodiment of the invention.

FIG. 6 is a chart showing an illumination timing of each light source of the projector according to the embodiment of the invention.

FIG. 7 is a schematic front view of a light source module equipped in the projector according to the embodiment of the invention, the light source module having a different arrangement of light sources.

FIG. 8 is a schematic front view of a light source module equipped in the projector according to the embodiment of the invention, the light source module having another different arrangement of light sources.

FIG. 9 is a schematic front view of a light source module equipped in the projector according to the embodiment of the invention, the light source module having a further different arrangement of light sources.

FIG. 10 is a schematic front view of a light source module equipped in the projector according to the embodiment of the invention, the light source module having a different arrangement of light sources.

FIG. 11 is a schematic front view of a light source module equipped in the projector according to the embodiment of the invention, the light source module having another different arrangement of light sources.

FIG. 12 is a chart showing an illumination timing of each light source of the projector according to the embodiment of the invention.

### DETAILED DESCRIPTION OF THE INVENTION

Hereinafter, an embodiment of the invention will be described in detail based on the drawings.

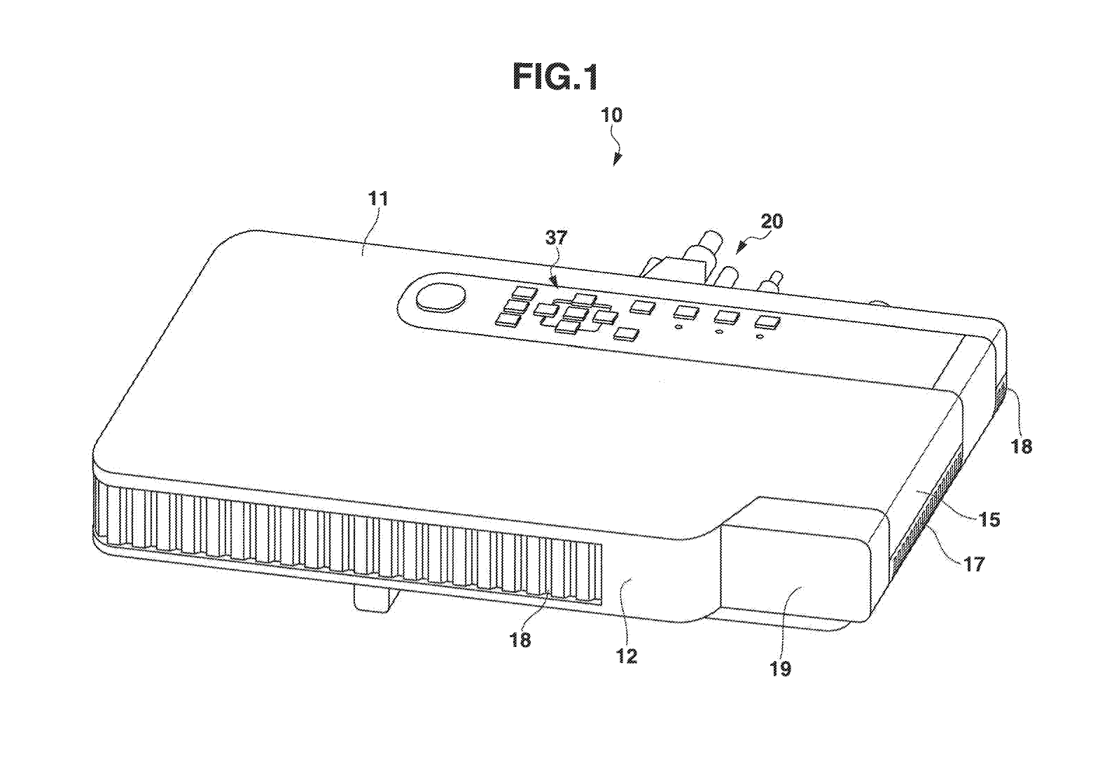

FIG. 1 is an external perspective view of a projector 10.

In this embodiment, when referred to in relation to the projector 10, left and right denote, respectively, left and right in relation to the projecting direction of the projector 10, and when referred to in relation to the projector 10, front and rear denote, respectively, front and rear in relation to the direction of a screen and a traveling direction of a pencil of light that is emitted from the projector 10 towards the screen.

As is shown in FIG. 1, the projector 10 according to this embodiment has a substantially rectangular parallelepiped shape.

The projector 10 has a lens cover 19 which covers a projection port which is disposed to a side of a front panel 12 which is referred to as a front side panel of a main body casing of the projector 10. Additionally, a plurality of outside air inlet slits 18 are provided in the front panel 12.

Further, although not shown, the projector 10 includes an IR reception unit which receives a control signal from a remote controller.

In addition, a keys/indicators unit 37 is provided on an upper panel 11 of the main body casing.

Disposed on this keys/indicators unit 37 are keys and indicators which include a power supply switch key, a projection switch key, a power indicator, an overheat indicator, and the like. The projection switch key is used for switching “on” or “off” of projection of the projector. The power indicator informs whether the projector 10 is on or off. The overheat indicator informs of an overheat condition occurring in a light source unit, a display element, a control unit or the like when they really overheat.

Additionally, the upper panel 11 covers an upper surface and part of a left-hand side surface of the projector casing and is configured as a panel that can be opened to deal with a failure when it occurs.

Further, provided in a back side or a back panel of the projector casing are an input/output connector unit where USB terminals, a video signal input D-SUB terminal, an S terminal, an RCA terminal and the like are provided and various types of terminals 20 including a power supply adaptor plug and the like.

Additionally, a plurality of outside air inlet slits 18 are formed in the back panel. A plurality of inside air outlet slits 17 are formed in each of a right-hand panel, not shown, which is a side panel of the projector casing and a left-hand panel 15 which is a side panel shown in FIG. 1.

In addition, outside air inlet slits 18 are also formed in a portion of the left panel 15 which lies near a corner portion between the back panel and itself. A plurality of outside air inlet slits and/or a plurality of inside air outlet slits are also formed on a front surface and a rear surface of a bottom panel, not shown, or in the vicinity of the bottom panel adjacent to the right-hand panel and the left-hand panel. Further, the right-hand panel and the left-hand panel 15 are formed when the upper panel 11 and a bottom panel are assembled together.

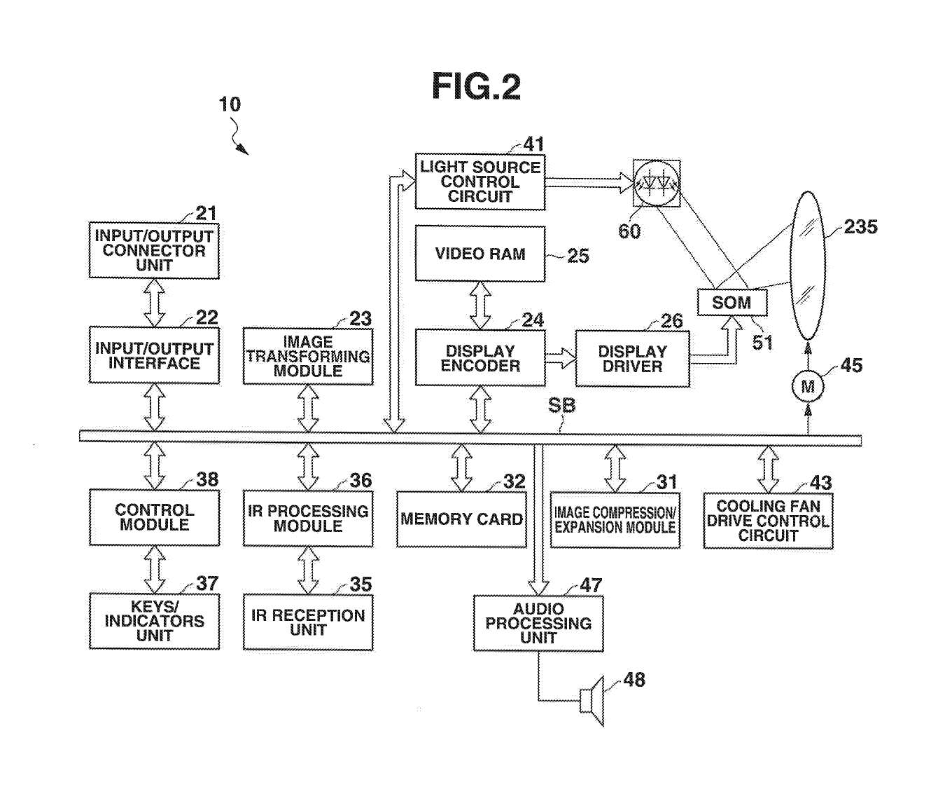

Next, a projector control unit of the projector 10 will be described by the use of a functional block diagram shown in FIG. 2. The projector control unit includes a control module 38, an input/output interface 22, an image transforming module 23, a display encoder 24, a display driver 26 and the like.

This control module 38 governs the control of respective operations of circuitries within the projector 10 and includes a CPU which is a controller, a ROM which stores infixed fashion operation programs of various types of settings, a RAM which is used as a working memory and the like.

An input/output connector unit 21 is connected to the input/output interface 22.

Image signals of various standards which are inputted from the input/output connector unit 21 are sent via the input/output interface 22 and a system bus (SB) to the image transforming module 23, where the image signals are transformed so as to be unified into an image signal of a predetermined format which is suitable for display by the projector control unit. Thereafter, the image signals so transformed are outputted to the display encoder 24.

The display encoder 24 deploys the image signals that have been inputted thereinto on a video RAM 25 for storage therein, generates a video signal from the contents stored in the video RAM. 25, and outputs the video signal so generated to the display driver 26.

The display driver 26 drives a display element 51, which is a spatial optical modulator (SOM), at an appropriate frame rate in response to the image signal outputted from the display encoder 24.

A pencil of light which is emitted from a light source unit 60 is shone onto the display element 51 via a light source-side optical system, whereby an optical image is formed by using reflected light which is reflected by the display element 51. The image so formed is then projected on to a projection surface for display thereon via a projection-side optical system.

In addition, a movable lens group 235 of the projection-side optical system is driven by a lens motor 45 for zooming or focusing.

When in a reproducing mode, an image compression/expansion module 31 performs the following operation. Specifically, the image compression/expansion module 31 reads out image data recorded on a memory card 32 and expands individual image data which make up a series of dynamic images frame by frame. Then, the image compression/expansion module 31 outputs the image data to the display encoder 24 via the image transforming module 23 so as to enable the display of dynamic images and the like based on the image data stored on the memory card 32.

Operation signals generated at the keys/indicators unit 37 which includes the main keys and indicators which are provided on the upper panel 11 of the main body casing of the projector 10 are sent out directly to the control module 38. Key operation signals from the remote controller are received by the IR reception unit 35, and a code signal demodulated at an IR processing module 36 is outputted to the control module 38.

The control module 38 controls a light source control circuit 41 which is configured as a light source control unit.

This light source control circuit 41 controls the illumination of laser light emitting elements installed in a laser light source module 70 as a light source device which will be described later in a time-sharing fashion so that light source lights in the predetermined ranges of wavelengths which are required in producing an image are emitted from the light source unit 60. The light source control circuit 41 controls a wheel motor 110 which is a driving device.

Additionally, the light source control circuit 41 controls the illumination of a red light emitting diode 121 as a red light source device 120.

Further, the control module 38 causes a cooling fan drive control circuit 43 to detect temperatures through a plurality of temperature sensors which are provided in the light source unit 60 and the like so as to control the rotating speed of cooling fans based on the results of the temperature detections.

In addition, an audio processing unit 47 is connected to the control module 38 via a system bus (SB). This audio processing module 47 includes a circuitry for a sound source such as a PCM sound source or the like. When in a projection mode and a reproducing mode, the audio processing unit 47 converts audio data into analog signals and drives a speaker 48 to output loudly sound or voice based on the audio data.

Next, an internal construction of the projector 10 will be described.

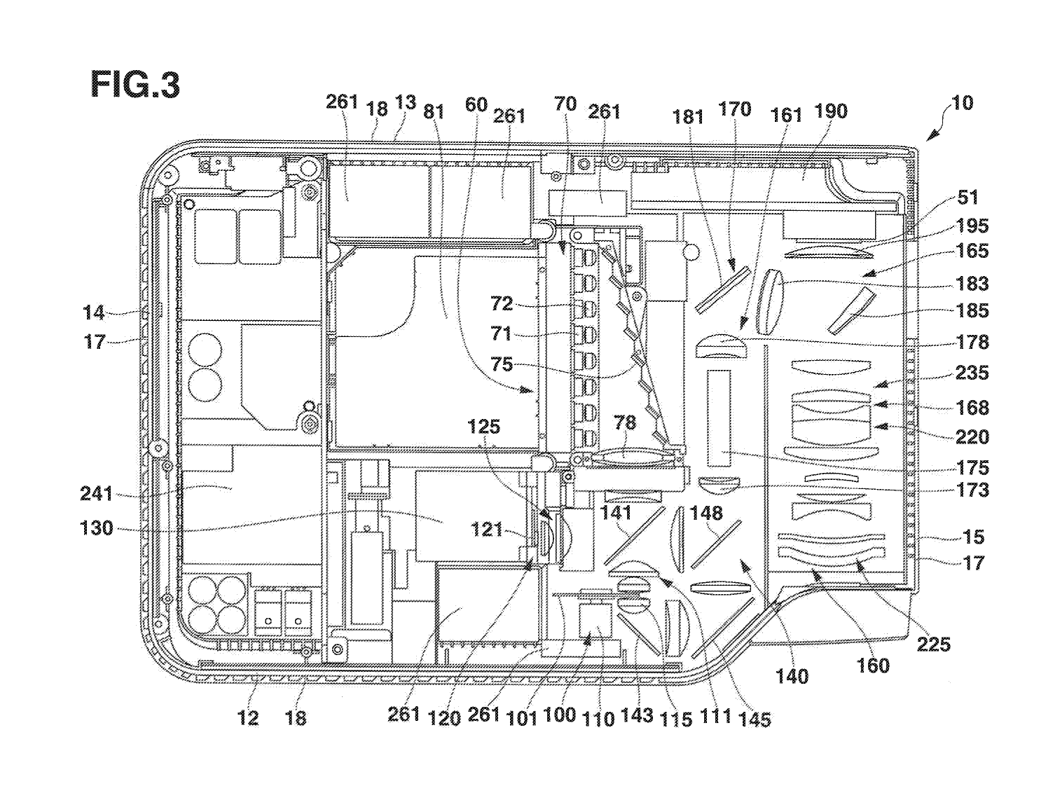

FIG. 3 is a schematic plan view showing an internal construction of the projector 10.

As shown in FIG. 3, the projector 10 includes a control circuit board 241 which is provided near the right-hand panel 14. This control circuit board 241 includes a power supply circuit block, a light source control block and the like. Additionally, the projector 10 includes the light source unit 60 which is provided to a side of the control circuit bard 241, that is, in a substantially central portion of the projector housing.

Further, in the casing of the projector 10, an illumination-side optical block 161 is disposed to a left side of the laser light source module 70 provided in the light source unit 60. This illumination-side optical block 161 includes part of a light source-side optical system 170 which is an optical system which guides light emitted from the light source unit 60 to the display element 51.

Additionally, an image generating optical block 165 is disposed near a position where the back panel 13 intersects the left-hand panel 15. The image generating optical block 165 includes a part of the light source-side optical system 170, the display element 51, and a part of a projection-side optical system 220 which is an optical system which projects a projection light which is generated in the display element 51 on to a screen.

Further, a projection-side optical block 168 is disposed at the front of the image generating optical block 165, and this projection-side optical block 168 includes the projection-side optical system 220.

The light source-side optical system 170 which is included in the illumination-side optical block 161 includes a collective lens 178 which concentrates light emitted from a light tunnel 175 of the light source unit 60, a light axis changing mirror 181 which changes the axis of a pencil of light emitted from the light tunnel 175 in the direction of the image generating optical block 165 and the like.

The light source-side optical system 170 which is included in the image generating optical block 165 includes a collective lens 183 which concentrates light source light which is reflected on the light axis changing mirror 181 on to the display element 51, and a shining mirror 185 which shines a pencil of light which passes through the collective lens 183 onto the display element 51 at a predetermined angle.

Additionally, in the image generating optical block 165, a cooling device 190 such as a heat sink which cools the display element 51 is disposed between a DMD which is the display element 51 and the back panel 13. The display element 51 is cooled by this heat sink. In addition, a condenser lens 195 which makes up apart of the projection-side optical system. 220 is disposed in the proximity of the front of the display element 51.

The projection-side optical block 168 includes, as the projection-side optical system 220, the fixed lens group 225 which is incorporated in a fixed lens barrel and the movable lens group 235 which is incorporated in a movable lens barrel.

Additionally, the projection-side optical system 220 is configured as a variable-focus lens with a zooming function, and zooming and focusing can be executed by moving the movable lens group 235 by the lens motor.

Next, the light source unit 60 of this embodiment will be described in detail.

The light source unit 60 has a luminous light emitting device 100. The luminous light emitting device 100 has the laser light source module 70, a light emitting plate 101 and the wheel motor 110.

The laser light source module 70 emits light having a wavelength in the blue wavelength range. The light emitting plate 101 includes a function to transmit the light in the blue wavelength range emitted from the laser light source module 70 while diffusing it and a function to generate green luminous light by using the light in the blue wavelength range as the excitation light.

The wheel motor 110 is a driving device which moves the light emitting plate 101.

Further, the light source unit 60 includes the red light source device 120, the light tunnel 175 and a light guiding optical system 140.

The red light source device 120 is disposed between the laser light source module 70 and the luminous light emitting device 100.

The light tunnel 175 is an optical member which functions so as to uniformly distribute the intensity of illumination of light which has passed therethrough.

The light guiding optical system 140 changes the directions of the axes of the lights emitted from the luminous light emitting device 100 and the axis of the light emitted from the red light source device 120 so that the axes of the lights are directed in the same direction and concentrates the lights of the individual colors to an incident entrance of the light tunnel 175.

In addition, the light source unit 60 has a cooling device 81 and a cooling fan 261 which cool the laser light source module 70, a cooling fan 261 which cools the luminous light emitting device 100 including the light emitting plate 101, and the like.

The laser light source module 70 is alight source module which includes a plurality of laser light emitting elements 71. The laser light source module 70 is disposed in a substantially central portion in relation to a left-to-right direction of the projector casing and near the back panel 13 so that axes of lights emitted from the laser emitting elements 71 become parallel to the back panel 13.

Additionally, as shown in FIG. 3, collimator lenses 72 are disposed at the front of the corresponding laser light emitting elements 71.

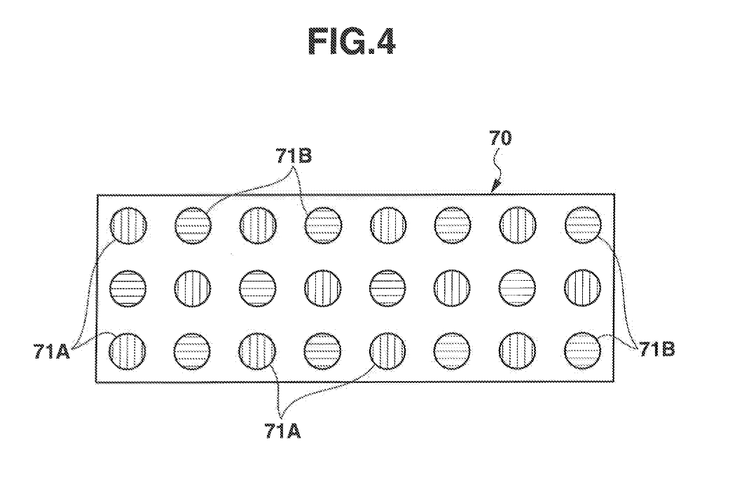

As shown in FIG. 4, the laser light source module 70 includes 24 blue laser light emitting elements 71, and first blue laser light emitting element 71A and second blue laser light emitting elements 71B are arranged in a check pattern (so as to lie alternately adjacent to each other vertically and horizontally). The first blue laser light emitting elements 71A and the second blue light emitting elements 71B emit lights having wavelengths which are slightly different.

Namely, the laser light source module 70 is such that a plurality of laser light emitting elements 71 of two different types which emit lights having different wavelengths are arranged on a single plane.

A blue laser light emitting element which emits light having a wavelength of 445 nm is used for the first blue laser light emitting elements 71A, and a blue laser light emitting element which emits light having a wavelength of 460 nm is used for the second blue laser light emitting elements 71B. Thus, the light source module 70 is configured so as to emit the lights having the wavelengths which are slightly different within the range of wavelengths of the same color.

A plurality of reflecting mirrors 75 are arranged as in steps of a staircase in front of the corresponding laser light emitting elements 71. The reflecting mirrors 75 constitute a part of the light guiding optical system 140 and change the directions of axes of lights emitted from the laser light emitting elements 71 by 90 degrees in the direction of the front panel 12. A collective lens 78 is disposed on the axes of the laser beams which are reflected by the reflecting mirrors 75.

The plurality of reflecting mirrors 75 reflect the lights emitted from the laser light emitting elements 71 so as to narrow distances between the lights so that a sectional area of a pencil of laser light emitted from the laser light source module 70 is small.

Additionally, a cooling device 81 such as a heat sink or the like is disposed between the laser light source module 70 and the right-hand panel 14 so as to cool the laser light source module 70. A cooling fan 261 is disposed between the heat sink and the back panel 13.

The first blue laser light emitting elements 71A and the second blue laser light emitting elements 71B which constitute the light source are cooled by the cooling fan 261 which is disposed between the heat sink, which is the cooling device 81, and the back panel 13 and the cooling device 81. Further, a cooling fan 261 is also disposed between the group of reflecting mirrors 75 and the back panel 13, and the group of reflecting mirrors 75 and the collective lens 78 are cooled by this cooling fan 261.

The luminous light emitting device 100 includes the light emitting plate 101, the wheel motor 110, a collective lens group 111, and a collective lens 115.

The light emitting plate 101 is disposed so as to be parallel to the front panel 12, that is, so as to be intersected at right angles with the axis of the light emitted from the laser light source module 70.

The wheel motor 110 drives to rotate the light emitting plate 101.

The collective lens group 111 concentrates the pencil of light emitted from the laser light source module 70 to the light emitting plate 101 and concentrates a pencil of light emitted in the direction of the back panel 13 from the light emitting plate 101.

The collective lens 115 concentrates a pencil of light emitted in the direction of the front panel 12 from the light emitting plate 101.

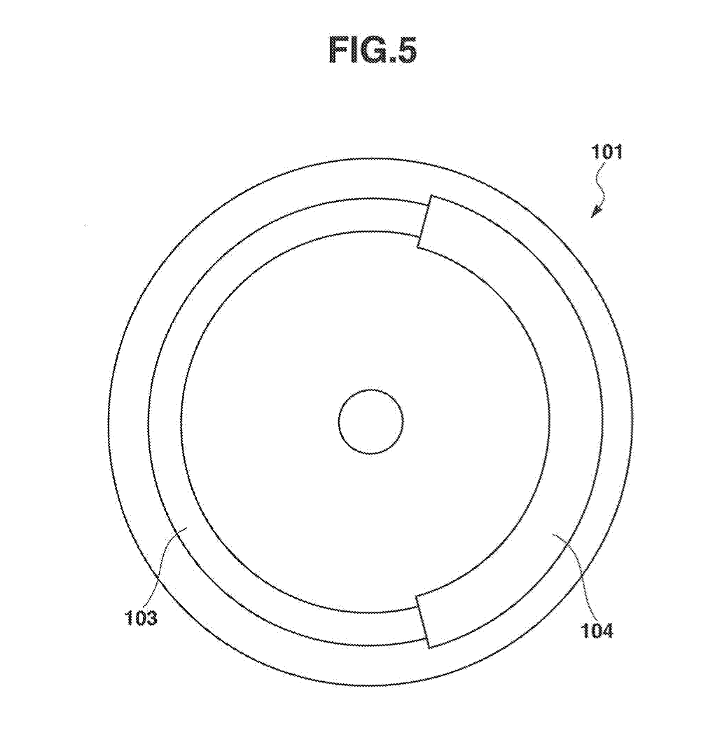

As shown in FIG. 3, the light emitting plate 101 of the luminous light emitting device 100 is disposed so that a part of the light emitting plate 101 is positioned on an optical path of the light emitted from the laser light source module 70 after having been reflected at the reflecting mirrors 75. Then, on this light emitting plate 101, as shown in FIG. 5, a luminous segment 103 and a transmitting segment 104 are provided in an end-to-end fashion in a circumferential direction. A luminous light emitting material is applied to the luminous segment 103, and this luminous light emitting material receives the light in the blue wavelength range emitted from the laser light emitting module 70 to emit light having a wavelength in the green wavelength range. The transmitting segment 104 transmits the light emitted from the laser light source module 70 while diffusing it.

A base material 102 of the light emitting plate 101, which is a rotary wheel, is a metallic material which is made up of copper, aluminum or the like. An annular groove is formed on a surface of the base material 102 of the rotary plate which lies on a side facing the laser light source module 70. A bottom portion of this groove is mirror finished through silver deposition or the like, and a layer of green luminescent material is laid out on a surface of the mirror finished groove.

This green luminescent material layer is made up of a green luminescent material such as YAG which emits luminous light having a wavelength in the green wavelength range by receiving the excitation light in the blue wavelength range which is emitted from the laser light source module 70 and a transparent binder such as glass in which the green luminescent material is uniformly scattered.

Then, the light in the blue wavelength range that is emitted from the laser light source module 70 to be shone on to the luminous segment 103 where the green luminescent material layer is laid out to make the light emitting plate 101 into a green light source device 80 excites the green luminescent material in the green luminescent material layer. Pencils of light which are luminescently emitted in every direction from the green luminescent material are directed directly towards the back panel 13 or indirectly towards the back panel 13 after having been reflected on a bottom surface of the groove portion on the light emitting plate 101 to thereby be incident on the collective lens group 111.

Further, in the transmitting segment 104, a transparent material that transmits light is fitted in a cut-out through-hole portion in the base material 102 of the rotary plate, and minute irregularities are formed on a surface of the transparent material through sand blasting. Consequently, the light in the blue wavelength range emitted from the laser light source module 70 and shone on to the transmitting segment 104 is diffused by the minute irregularities into diffuse transmission light, which is then transmitted through the light emitting plate 101 to be incident on the collective lens 115.

A cooling fan 261 is disposed between the wheel motor 110 and the front panel 12, and the luminous light emitting device 100 is cooled by the cooling fan 261.

The red light source device 120 is a monochromatic light emitting device which includes a red light emitting diode 121 and a collective lens group 125. The red light emitting diode 121 is disposed so that the optical axis thereof becomes parallel to the blue laser light emitting elements 71. The collective lens group 125 concentrates light emitted from the red light emitting diode 121. This red light emitting diode 121 is a light emitting diode which emits light having a wavelength in the red wavelength range.

The red light source device 120 is disposed so that the axes of the light emitted from the laser light source module 70 and the light in the green wavelength range emitted from the light emitting plate 101 intersect the axis of the light in the red wavelength range which is emitted therefrom at right angles. Further, the red light source device 120 includes a heat sink 130 which is disposed at a side of the red light emitting diode 121 which faces the right-hand panel 14. Additionally, a cooling fan 261 is disposed between the heat sink 130 and the front panel 12, whereby the red light emitting diode 121 which constitutes a red light source is cooled by the cooling fan 261.

Then, the light guiding optical system 140 includes the collective lenses which concentrate pencils of light in the blue, green and red wavelength ranges, the reflecting mirrors which change the directions of the axes of the pencils of light in those wavelength ranges so that they are directed in the same direction, dichroic mirrors and the like.

The light guiding optical system 140 guides the light emitted from the laser light source module 70, the light emitted from the light emitting plate 101 of the luminous light emitting device 100 and the light emitted from the red light source device 120 so that the lights are incident on the light tunnel 175, together with the group of reflecting mirrors 75 which reflect the lights emitted from the laser light emitting elements 71 and the collective lens 78 which concentrates these reflected light.

Specifically speaking, the light guiding optical system 140 has the group of reflecting mirrors 75 and the collective lens 78 in the laser light source module 70 and has further a first dichroic mirror 141 in a position where the light in the blue wavelength range which is emitted from the laser light source module 70 and the light in the green wavelength range which is emitted from the light emitting plate 101 intersect the light in the red wavelength range which is emitted from the red light source device 120 at right angles.

The dichroic mirror 141 transmits the light in the blue wavelength range and the light in the red wavelength range and reflects the light in the green wavelength range which is emitted from the luminous light emitting device 100 in such a way as to change the direction of the axis of the green light by 90 degrees in the direction of the left-hand panel 15.

Additionally, the light guiding optical system 140 includes a first reflecting mirror 143 which is disposed on the axis of the light in the blue wavelength range which passes through the light emitting plate 101 while diffusing it, that is, between the collective lens 115 and the front panel 12. This first reflecting mirror 143 reflects the light in the blue wavelength range so as to change the axis of the blue light by 90 degrees in the direction of the left-hand panel 15.

The light guiding optical system. 140 has further a second reflecting mirror 145 which is disposed on the axis of the light in the blue wavelength range which is reflected on the first reflecting mirror 143 and near an optical system unit 160. The second reflecting mirror 145 changes the direction of the axis of this blue light by 90 degrees in the direction of the back panel 13.

Further, a second dichroic mirror 148 is disposed in a position where the axis of the light in the red wavelength range which passes through the first dichroic mirror 141 and the axis of the light in the green wavelength range which is reflected by the first dichroic mirror 141 so that the axis thereof coincides with the axis of the red light intersect the axis of the light in the blue wavelength range which is reflected by the second reflecting mirror 145 at right angles. The second dichroic mirror 148 transmits the light in the blue wavelength range and reflects the light in the red wavelength range and the light in the green wavelength range in such away as to change the directions of the axes of the lights by 90 degrees in the direction of the back panel 13.

Additionally, collective lenses are disposed individually between the dichroic mirrors and the reflecting mirrors. Further, a collective lens 173 is disposed near the light tunnel 175, and this collective lens 173 concentrates the light source lights to the incident entrance of the light tunnel 175.

Consequently, in such a state that the wheel motor 110 is driven to rotate the light emitting plate 101, the first flue laser light emitting elements 71A of the laser light source module 70 are illuminated at a timing when the luminous segment 103 is positioned on the axis of the light which is emitted from the laser light source module 70 and which passes through the first dichroic mirror 141 so that the pencil of blue laser light emitted from the blue laser light emitting elements 71A is shone on to the luminous segment 103 of the light emitting plate 101 as the excitation light. Then, this enables light having a wavelength in the green wavelength range to be emitted from the green luminescent material applied to the luminous segment 103.

Then, the second blue laser light emitting elements 71B of the laser light source module 70 are illuminated at a timing when the transmitting segment 104 of the light emitting plate 101 is positioned on the axis of the light which is emitted from the laser light source module 70 and which passes through the first dichroic mirror 141 so that the pencil of blue laser light emitted from the second blue laser light emitting elements 71B passes through the transmitting segment 104. This enables the light in the blue wavelength range to be emitted from the transmitting segment 104 in the form of diffuse light.

In this way, the driving of the wheel motor 110 and the illumination of the first blue laser light emitting elements 71A and the second blue laser light emitting elements 71B are controlled synchronously by the light source control circuit 41 so that the light in the green wavelength range can be emitted from the luminous segment 103 of the light emitting plate 101 by using the blue laser light from the first blue laser light emitting elements 71A as the excitation light and the light in the blue wavelength range generated by the second blue laser light emitting elements 71B can be emitted from the transmitting segment 104 of the light emitting plate 101.

Thus, in functioning as a synchronous control module, the light source control circuit 41, which is the light source control module, controls synchronously the illumination of the first blue laser light emitting elements 71A and the second blue laser light emitting elements 71B of the laser light source module 70, and the rotation of the wheel motor 110 of the luminous light emitting device 100. Additionally, the light source control circuit 41 controls the illumination of the red light emitting diode 121 which is the light source of the red light source device 120 in synchronism with the synchronous control described above.

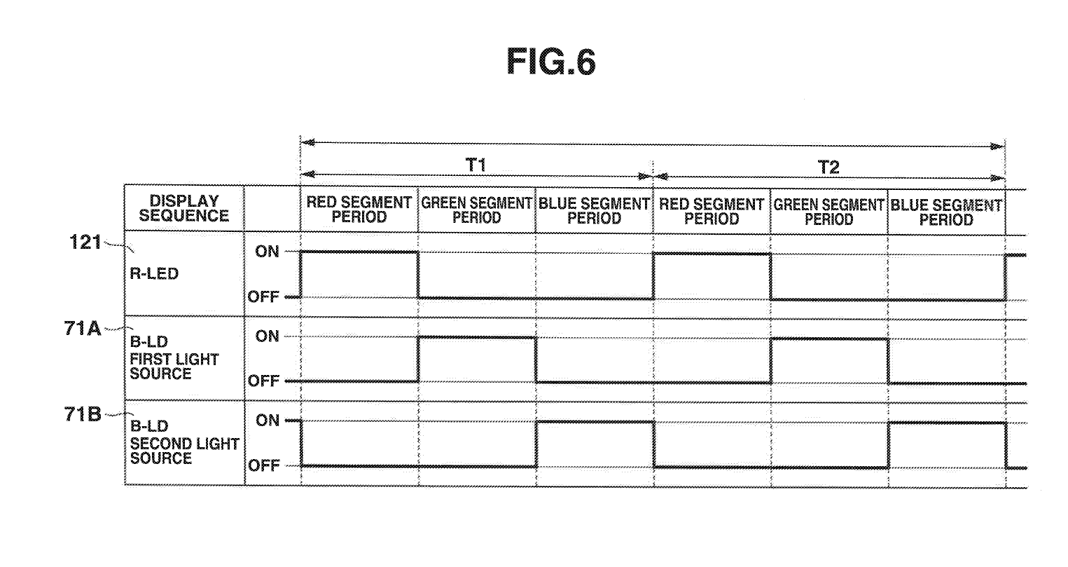

Consequently, by controlling the emission of the light in the red wavelength range from the red light emitting diode 121 which is the red light source of the red light source device 120 in synchronism with the control of the illumination of the first and second laser light emitting elements 71A, 71B and the rotation of the wheel motor 110, as shown in FIG. 6, a red segment period, a green segment period and a blue segment period can be generated. Specifically, the red light emitting diode 121 (R-LED) is illuminated in the red segment period. In the green segment period, the first laser light emitting elements 71A (B-LD) which constitute the first light sources are illuminated so that the luminous light is emitted from the green luminescent material. In the blue segment period, the second blue laser light emitting elements 71B (B-LD) which constitute the second light sources are illuminated so that the light in the blue wavelength range is emitted from the transmitting segment 104 of the light emitting plate 101 while being diffused by the transmitting segment 104.

In this way, the red light emitting element 121 is made to constitute the red light source. The first blue laser light emitting elements 71A which constitute the first light sources function as the excitation light source which emits the excitation light to the green luminescent material so that the luminous light in the green wavelength range is emitted from the luminous segment 103 of the light emitting plate 101. Thus, the luminous segment 103 is configured as the green light source. The second laser light emitting elements 71B which constitute the second light sources function as the blue light source. Thus, the light emitted from the first light sources can be the light having the wavelength suitable to cause the luminescent material to emit luminous light efficiently. This makes it easy for the luminescent material to emit a large quantity of bright green light.

The light in the blue wavelength range which is emitted from the second light source is intended to be shone on to the display element after passing through the transmitting segment 104 of the light emitting plate 101 to thereby form a blue image. Therefore, the blue light can be the blue light having the high color developing capability and the wavelength in the blue wavelength range which is suitable for color matching with images produced by the red light and the green light, that is, the blue light which is suitable for generating a natural tone when matched with the red light and the green light.

Additionally, the first light sources and the second light sources are arranged in the check pattern, and therefore, the in-plane unevenness in luminous flux in the light having the first wavelength which is emitted from the first light source and the light having the second wavelength which is emitted from the second light source can be reduced.

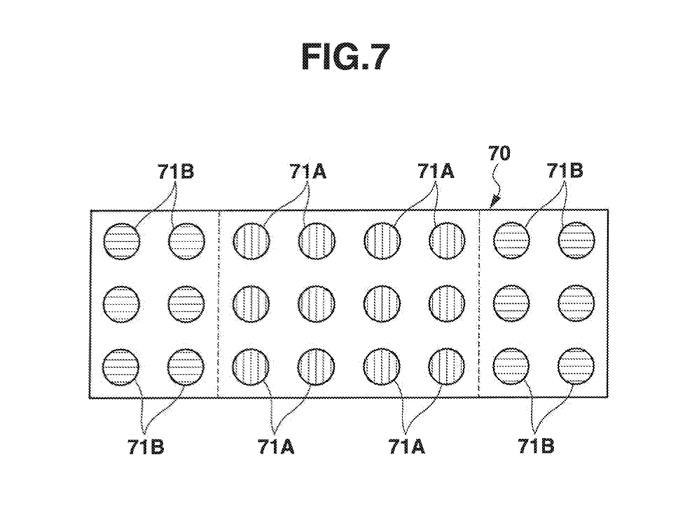

When 24 laser light emitting elements 71 are used to be arranged in three rows and eight columns as the light source module, it is not that 12 first blue laser light emitting elements 71A which are the first light sources and 12 second blue laser light emitting elements 71B which are the second light sources are disposed in the check pattern but that as shown in FIG. 7, a configuration may be adopted in which 12 first blue laser light emitting elements 71A are disposed in three rows and four columns in a central portion, while 12 second blue laser light emitting elements 71B are divided into two groups of six second blue laser light emitting elements 71B which are each arranged in three rows and two columns so that the groups are disposed at left- and right-hand sides of the first blue laser light emitting elements 71A, whereby those 12 first blue laser light emitting elements 71A are collected to the central portion so that the lights shone from the first blue laser light emitting elements 71A are concentrated to the luminescent material.

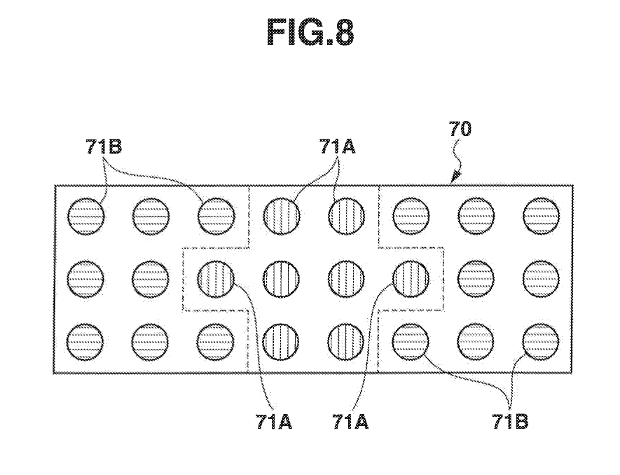

In addition, when the number of first blue laser light emitting elements 71A to be provided and the number of second blue laser light emitting elements 71B to be provided are different, as shown in FIG. 8, a configuration may be adopted in which with first blue laser light emitting elements 71A collected to a central portion of a light source module, second blue laser light emitting elements 71B are disposed symmetrical with respect to the first blue laser light emitting elements 71A vertically and laterally, that is, the first blue laser light emitting elements 71A and the second blue laser light emitting elements 71B are disposed in point symmetry with respect to the center of the light source module.

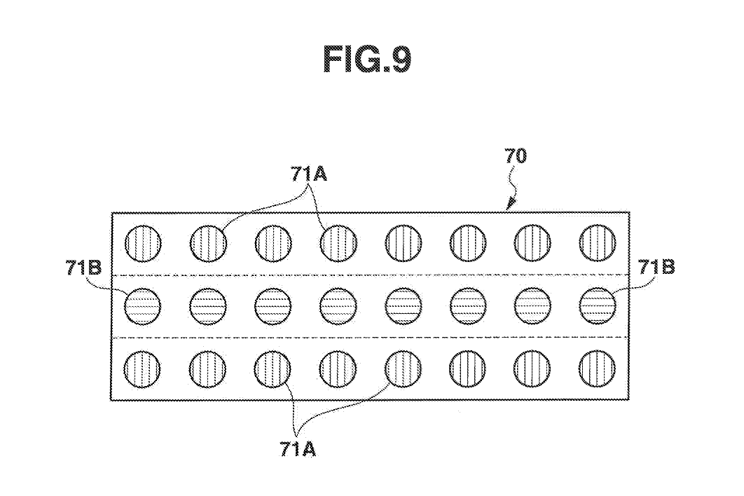

When the number of first blue laser light emitting elements 71A which are the first light sources for exciting the luminescent material needs to be larger than the number of second blue laser light emitting elements 71B which are the second light sources, as shown in FIG. 9, a configuration may be adopted in which two rows of eight first laser light emitting elements 71A are disposed as top and bottom rows of a light source module with a row of eight second laser light emitting elements 71B disposed vertically therebetween as a middle row.

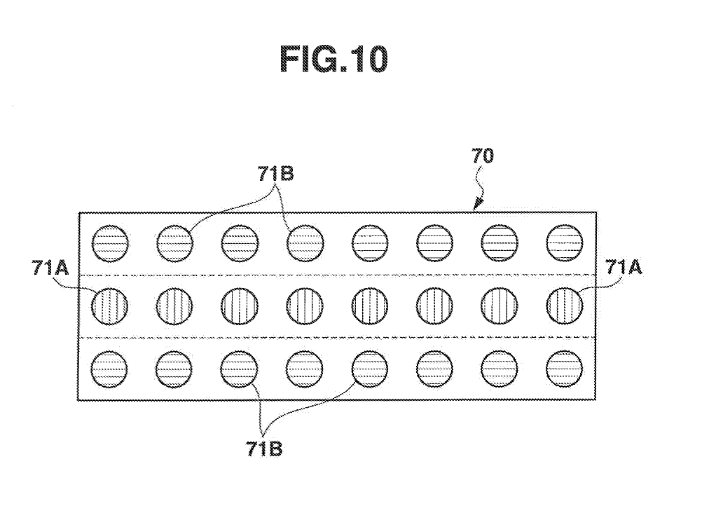

When the number of second blue laser light emitting elements 71B needs to be larger than the number of first blue laser light emitting elements 71A, as shown in FIG. 10, a configuration may be adopted in which two rows of second blue laser light emitting elements 71B are disposed as top and bottom rows of a light source module with a row of first blue laser light emitting elements 71A disposed vertically therebetween as a middle row.

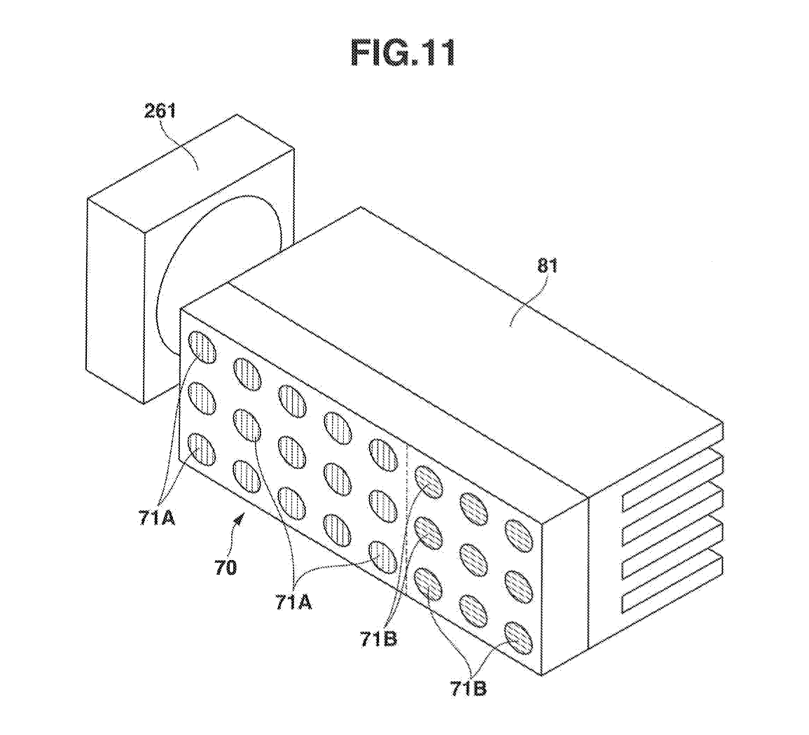

Further, in this embodiment, the heat value of the first blue laser light emitting element 71A is larger than the heat value of the second blue laser light emitting element 71B. Therefore, when the light source module made up of the first blue laser light emitting elements 71A and the second blue laser light emitting elements 71B is attached to a front surface of a cooling device, as shown in FIG. 11, in fixing the light source module to a cooling device 81 which is a heat sink, the blue laser light emitting elements may be disposed so that the first blue laser light emitting elements 71A are collected to an upstream side of a flow of cooling air which lies near to a cooling fan 261. According to this configuration, the cooling efficiency of the laser light emitting elements 71 can be enhanced, that is, the light source module can be cooled efficiently.

In this way, the first blue laser light emitting elements 71A and the second blue laser light emitting elements 71B do not necessarily have to be provided in the same number. Hence, the first blue laser light emitting elements 71A and the second blue laser light emitting elements 71B are disposed in appropriate numbers in the light source module according to a quantity of light in the green wavelength range which is emitted from the green luminescent material, a quantity of light in the blue wavelength range which is emitted from the second blue laser light emitting elements 71B and further a quantity of light in the red wavelength range which is emitted from the red light emitting diode 121 and based on the light emitting characteristics of the luminescent material or the light emitting characteristics of the laser light emitting elements 71 which are used for the first light sources and the second light sources.

The first blue laser light emitting element 71A which constitutes the first light source and the second blue laser light emitting element 71B which constitutes the second light source may be provided one each depending upon quantities of light required.

In this way, the first blue laser light emitting elements 71A which constitute the first light sources which emit the light having the first wavelength are used to excite the green luminescent material, and the second blue laser light emitting elements 71B are used as the second light sources which emit the light having the second wavelength which is slightly different from the wavelength of the light from the first light sources. This makes it possible to cause the green luminescent material to emit highly bright light by using the laser light emitting elements which emit the light having the wavelength at which a large quantity of light is emitted from the green luminescent material efficiently, thereby making it possible to form a bright green image which is necessary to generate a projection image.

In addition, the light in the blue wavelength range which is emitted from the second blue laser light emitting elements 71B which are the second light sources emitting the light having the wavelength which is slightly different from the wavelength of the light emitted from the first blue laser light emitting elements 71A is used to form a blue image which is used to form the projection image. This makes it possible to form a blue image with a high picture which can help to produce a natural tone when combined together with a green image and a red image, thereby making it easy to generate a bright projection image.

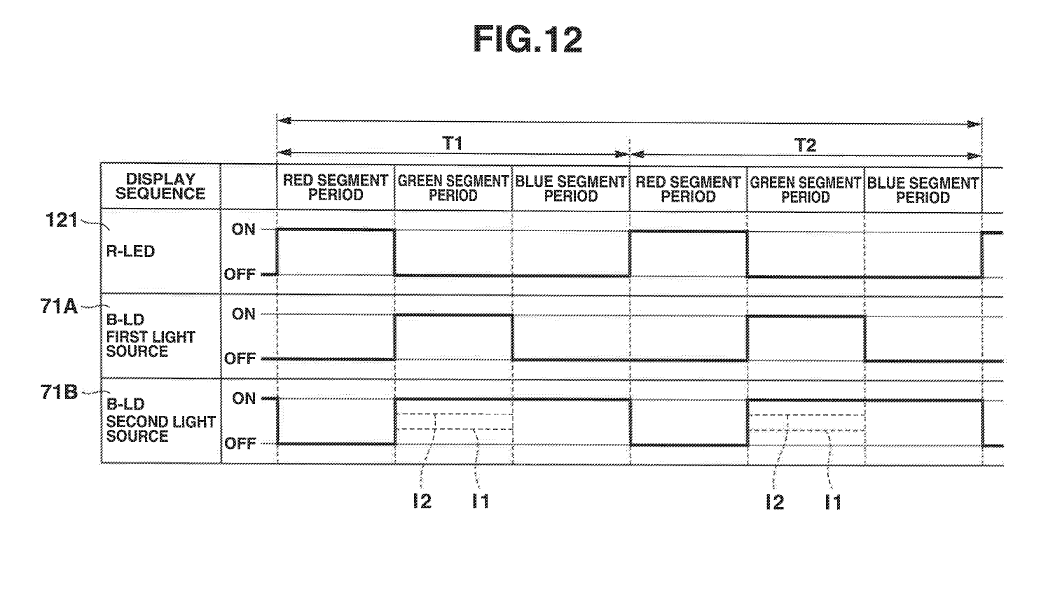

Then, when a highly bright image needs to be projected to form a projection image which can easily be captured by, for example, viewers who attend a presentation carried out in a bright room, as shown in FIG. 12, the second blue laser light emitting elements 71B may be illuminated at the same timing when the first blue laser light emitting elements 71A are illuminated in the green segment period.

In this way, the light in the blue wavelength range which is emitted from the second blue laser light emitting elements 71B has the wavelength which is close to the wavelength of the light of the similar color which is emitted from the first light sources. Therefore, it is also possible to excite the luminescent material by the light emitted from the second blue laser light emitting elements 71B. By adopting this configuration, the light emitted from the second blue laser light emitting elements 71B can be used to excite the luminescent material together with the light emitted from the first blue laser light emitting elements 71A to thereby increase the quantity of light in the green wavelength range to be emitted from the luminescent material, thereby enabling a projection of a highly bright mode.

In illuminating the second blue laser light emitting elements 71B at the same timing when the first blue laser light emitting elements 71A are illuminated, not only may an electric current of a reference current value be applied to the second blue laser light emitting elements 71B, but also the current value may be changed.

Specifically, an electric current having a current value I1 which is smaller than the reference current value is applied to enhance slightly a luminance level so as to match the luminance level of the highly bright mode. Alternatively, an electric current having a current value I2 which is higher than the current value I1 but is lower than the reference current value is applied to enhance the luminance level. Further, the electric current having the reference current value is applied so as to enhance the luminance level up to a maximum level. In this way, it is possible to set the luminance level in stages.

In setting the luminance level, the invention is not limited to the approach of changing the current value. With the light source module where the plurality of second blue laser light emitting elements 71B are used, the luminance level may be controlled by changing the quantity of light in the green wavelength range by controlling the number of second blue laser light emitting elements 71B to be illuminated in synchronism with the illumination of the first blue laser light emitting elements 71A.

In addition, while the light emitting wheel is used as the light emitting plate, the invention is not limited thereto. Any configuration will suffice, provided that a diffuse transmission plate functioning as the transmitting segment 104 and a luminous segment 103 having a green luminescent material layer are configured to be provided in an end-to-end fashion.

Namely, it is possible to use a rectangular light emitting plate or light emitting plates of other different shapes. Additionally, as the driving device, an actuator or the like which can move the light emitting plate 101 rectilinearly may be used in place of the wheel motor 110.

Namely, when the luminescent plate which functions as the luminous segment 103 and the diffuse transmission plate which functions as the transmitting segment 104 are moved so as to be positioned on the optical path of the light emitted from the laser light source module 70, a light deflector using a KTN crystal, an acousto-optic device, an MEMS mirror or the like may be used as the driving device.

In this way, in this embodiment, the light source unit has the first light sources and the second light sources. The first light sources and the second light sources emit lights which fall within a range of wavelengths of similar colors and have the wavelengths which are slightly different from each other. This enables the luminescent material to be excited efficiently so as to emit highly bright luminous light. Additionally, with this configuration, it is possible to provide the small light source unit 60 which emits light which exhibits good tone and color developing characteristics when light from the second light sources is combined with luminous light.

Then, with this light source unit 60 used in the projector, it is possible to provide the projector 10 which can project an image which is bright and superior in color reproducibility and which has a high picture quality.

In addition, since the number of first light sources and the number of second light sources are different, it is possible to provide easily the light source unit 60 which can be configured as required according to the light emitting efficiency of the light sources or the excitation efficiency of the luminescent material.

Additionally, since the first light sources and the second light sources are disposed in point symmetry, the in-plane irregularities in lights emitted from the first light sources and the second light sources can be reduced to thereby enhance the uniformity in luminous flux. Further, even though an installation error is generated more or less in the rolling direction of the optical axes of the light sources, it is possible to suppress the change in luminous flux distribution to a lower level.

Arranging the first light sources and the second light sources alternately in the vertical and horizontal directions can facilitate the uniform distribution of intensity in light emitted from the light source module.

In addition, in this light source unit 60, luminous light and transmitted light are formed by the use of the light emitting plate 101 which has the luminous segment 103 and the transmitting segment 104, and the light guiding optical system is provided so as to concentrate the luminous light and the transmitted light to the same optical path. Thus, it is possible to provide easily the small light source unit 60 which can emit the light having the second wavelength and the luminous light having the wavelength which is different from the second wavelength and the color which is different from that of the transmitted light. Additionally, forming the diffusing layer on the transmitting segment 104 enables the light from the second light sources to easily be diffused to thereby emit the light having the high in-plane uniformity in terms of intensity distribution as the light having the second wavelength.

In the light source unit 60, the first and second light sources are controlled synchronously by rotating the light emitting plate 101 using the wheel motor 110. This enables the light from the second light sources and the luminous light to be emitted in a time-sharing fashion easily and in an ensured fashion. Then, synchronizing the rotation of the light emitting plate 101 with the illumination of the first and second light sources enables the bright luminous light and the light from the second light sources which has the good color reproducibility to be emitted in the time-sharing fashion in an ensured fashion.

Additionally, by adopting the configuration in which the second light sources are illuminated at the same timing as the first light sources are illuminated, the light source unit 60 can deal with the high luminance mode in which the luminance of the luminous light is enhanced to enable a bright projection.

Further, by controlling the illuminating current value of the second light sources or the number of second light sources to be illuminated, the high luminance mode can be set in stages, whereby the power consumption can be made efficient while ensuring the luminance according to the required brightness.

Since the light source unit 60 includes the optical member which functions so as to uniformly distribute the intensity of illumination of light which has passed through it, it is possible to reduce the in-plane unevenness of emitted light to thereby enhance the uniformity in luminous flux of the emitted light.

In disposing the first light sources which are light sources having the larger heat value than that of second light sources with respect to the cooling device, since the first light sources are disposed so as to face a side of the cooling fan 261, the light source module can be cooled with good efficiency.

Additionally, since the first wavelength and the second wavelength fall in the blue wavelength range, it is possible to emit the blue light having the good color reproducibility based on the second wavelength. Then, it is possible to emit the highly bright green light by causing the luminous light in the green wavelength range to be emitted from the luminescent material.

While the invention has been described in detail and by reference to the embodiment and the several modified examples thereof, the embodiment and its modified examples are intended not to limit the scope of the invention but to be used for better understanding of the invention.

The novel embodiment and modified examples can be carried out in other various forms and various omissions, replacements and alterations can be made thereto without departing from the spirit and scope of the invention. Thus, the resulting embodiments and modifications are to be included in the spirit and scope of the invention and the scope of inventions claimed and equivalents thereof.

What is claimed is:

1. A light source unit, comprising:
a light source module; and
a light source control module, wherein the light source module comprises:
a first light source which emits light having a first wavelength which is used as excitation light which excites a luminescent material; and
a second light source which emits light having a second wavelength which is different from the first wavelength but which falls within a range of wavelengths of light of a similar color to that of the light of the first light source, and wherein
the light source control module controls individually the illumination of the first light source and the second light source.

2. The light source unit according to claim 1, wherein
the light source module includes the first light source and the second light source, wherein the numbers of the first light source/s and the numbers of the second light source/s are different from each other.

3. The light source unit according to claim 1, wherein
the light source module is made up of light source groups which include a plurality of at least either first light sources or second light sources, and wherein
the first light source/s or the second light source/s and the second light sources or the first light sources are arranged in point symmetry with respect to a substantial center of the light source module.

4. The light source unit according to claim 1, wherein
the light source module is made up of light source groups which are constituted by a plurality of first light sources and a plurality of second light sources, and wherein
the first light sources and the second light sources are arranged alternately vertically and horizontally.

5. The light source unit according to claim 1, comprising further;
a light emitting plate having a luminous segment which is excited by light emitted from the first light source to emit luminous light, and a transmitting segment which transmits light emitted from the second light source; and
a light guiding optical system which concentrates the luminous light and transmitted light which is transmitted through the transmitting segment on to the same optical path.

6. The light source unit according to claim 5, wherein
a diffusing layer is formed on the transmitting segment.

7. The light source unit according to claim 5, wherein
the light emitting plate is formed into a circular disc shape on which the luminous segment and the transmitting segment are provided in an end-to-end fashion in a circumferential direction, wherein
a driving device for rotating the light emitting plate is provided further, and wherein
the light source control module includes a synchronous control module which controls individually illuminations of the first light source and the second light source when the luminous segment and the transmitting segment of the light emitting plate which is rotated by the driving device are located in a predetermined position.

8. The light source unit according to claim 7, wherein
the synchronous control module synchronizes the rotation of the light emitting plate with the illuminations of the first light source and the second light source so that light from the first light source is shone on to the luminous segment and light from the second light source is shone on to the transmitting segment.

9. The light source unit according to claim 8, wherein
the synchronous control module also illuminates the second light source when the synchronous control module illuminates the first light source.

10. The light source unit according to claim 9, wherein
the light source control module enables an illumination current value of the second light source to be controlled when the first light source and the second light source are illuminated at the same time.

11. The light source unit according to claim 10, comprising:
a plurality of at least second light sources, and wherein
the light source control module control the number of second light sources to be illuminated when the light source control module illuminates the first light source and the second light sources at the same time.

12. The light source unit according to claim 5, comprising further:
an optical uniforming member which uniforms an intensity distributions of the luminous light and the transmitted light which are directed to the same optical path by the light guiding optical system.

13. The light source unit according to claim 1, comprising further:
a cooling fan which cools the light source module, wherein
either of the first light source or the second light source which has a larger heat value is disposed at a side facing the cooling fan.

14. The light source unit according to claim 13, wherein
the first wavelength and the second wavelength fall within a blue wavelength range.

15. The light source unit according to claim 1, wherein
the luminescent material which is excited when light having the first wavelength is shone on thereto emits luminous light having a wavelength falling in a green wavelength range.

16. A projector comprising:
the light source unit according to claim 1;
a display element which generates projection light;
a light source-side optical system which guides light emitted from the light source unit to the display element;
a projection-side optical system which guides the projection light generated in the display element; and
a projection control unit which controls the display element and the light source unit.
